(19) United States
(12) Patent Application Publication
(10) Pub. No.: US 2018/0368558 A1
(43) Pub. Date: Dec. 27, 2018

(54) METHOD AND SYSTEM FOR PROVIDING CUSTOM COSMETIC PRODUCTS

(71) Applicant: Susan Park, Sunnyvale, CA (US)

(72) Inventor: Susan Park, Sunnyvale, CA (US)

(21) Appl. No.: 15/953,328

(22) Filed: Apr. 13, 2018

Related U.S. Application Data
(60) Provisional application No. 62/485,280, filed on Apr. 13, 2017.

(51) Int. Cl. A45D 44/00; B01F 13/10; B01F 15/06

(52) U.S. Cl. CPC A45D 44/005; B01F 13/1058; B01F 2015/061; B01F 15/065; B01F 2215/0031; B01F 13/1061

(57) ABSTRACT

A system for providing custom cosmetic products includes a lower base configured to receive a plurality of containers, an upper base, and a plurality of dispensing cylinders coupled to the upper base. The dispensing cylinders are configured to selectively deposit cosmetic ingredients into the containers.

### CROSS-REFERENCE TO RELATED APPLICATION

This utility patent application claims priority to and the benefit of U.S. Provisional Patent Application Ser. No. 62/485,280, filed Apr. 13, 2017 and entitled “METHOD AND SYSTEM FOR PROVIDING CUSTOM COSMETIC PRODUCTS,” the entire content of which is incorporated herein by reference.

### BACKGROUND

### 1. Field

Aspects of example embodiments of the present disclosure relate to a method of providing custom cosmetic products and a system providing the same.

### 2. Related Art

Generally, a customer visits a cosmetics store, in-person and/or online, and purchases one or more of a number of premade cosmetic products. Because the cosmetic products are premade, the customer must select what is nearest to his or her desires rather than exactly what the customer wants. Also, premade cosmetic products may have a limited shelf-life and, in this case, may already be near their expiration date at the time of purchase. To extend the shelf-life of premade cosmetic products, companies may use preservatives or the like in the cosmetic products. However, these preservatives may cause a negative reaction in some users, such as dry skin, a rash, etc.

Recently, some companies have marketed custom cosmetic products. However, in these instances, the cosmetic products are mixed manually either by the customers themselves or by store employees. Such hand-mixed cosmetics products are expensive, and due to the time necessary to mix each requested cosmetic product, a single store may not be able to make enough custom cosmetic products to meet customer demand.

### SUMMARY

The present disclosure is directed toward various embodiments of a method of providing custom cosmetic products and a system providing the same.

According to one embodiment of the present disclosure, a system for providing custom cosmetic products includes a lower base configured to receive a plurality of containers, an upper base, and a plurality of dispensing cylinders coupled to the upper base. The dispensing cylinders are configured to selectively deposit cosmetic ingredients into the containers.

The lower base may include a fixed lower base and a rotatable lower base rotatably coupled to the fixed lower base. The rotatable lower base may be configured to receive the containers.

The containers received by the rotatable lower base may be aligned with the dispensing cylinders.

The rotatable lower base may be configured to rotate to align the containers with different ones of the dispensing cylinders.

Each of the dispensing cylinders may include an inner cylinder and an outer wall spaced apart from the inner cylinder.

The inner cylinder may be configured to receive the cosmetic ingredient.

The system may further include a refrigeration unit in the lower base. The refrigeration unit may be connected to the dispensing cylinders and may be configured to provide a cooling gas to a space between the inner cylinder and the outer wall of the dispensing cylinders.

The upper base may be configured to rotate relative to the lower base.

The upper base and the lower base may be coupled to each other by a support extending from the lower base to the upper base.

According to another embodiment of the present disclosure, a method of producing a custom cosmetic product by using a cosmetics dispensing system includes: receiving a skin type analysis result; rotating a lower base of the cosmetics dispensing system such that a container accommodated on the lower base is aligned under a first one of a plurality of dispensing cylinders; and dispensing a first ingredient from the first one of the dispensing cylinders into the container.

The method may further include rotating the lower base such that the container is aligned under a second one of the dispensing cylinders and dispensing a second ingredient from the second one of the dispensing cylinders into the container.

The method may further include providing a cooling gas from a refrigeration unit in the lower base to the dispensing cylinders.

The cooling gas may be provided to the dispensing cylinders via inlet openings in the dispensing cylinders, and the dispensing of the first ingredient may include closing an outlet valve in the first one of the dispensing cylinders to increase pressure in the first one of the dispensing cylinders.

The dispensing of the first ingredient may include opening a valve at a bottom of the first one of the dispensing cylinders.

The dispensing of the first ingredient may further include increasing pressure in the first one of the dispensing cylinders by using a piston.

The method may further include centrifuging the container by spinning the lower base after the dispensing of the second ingredient.

According to another embodiment of the present disclosure, a method of producing a custom cosmetic product by using a cosmetics dispensing system includes: receiving a skin type analysis result; rotating an upper base of the cosmetics dispensing system such that a first one of a plurality of dispensing cylinders is aligned over a container accommodated on a lower base of the cosmetics dispensing system; and dispensing a first ingredient from the first one of the dispensing cylinders into the container.

The method may further include rotating the upper base such that a second one of the dispensing cylinders is aligned over the container and dispensing a second ingredient from the second one of the dispensing cylinders into the container.

The method may further include mixing the first and second ingredients in the container.

The method may further include providing a cooling gas from a refrigeration unit in the lower base to the dispensing cylinders.

This summary is provided to introduce a selection of features and concepts of example embodiments of the present disclosure that are further described below in the detailed description. This summary is not intended to identify key or essential features of the claimed subject matter nor is it intended to be used in limiting the scope of the claimed subject matter. One or more of the described features according to one or more example embodiments may be combined with one or more other described features according to one or more example embodiments to provide a workable method or device.

### BRIEF DESCRIPTION OF THE DRAWINGS

FIG. 1A illustrates a skin-type determining machine according to an embodiment of the present disclosure;

FIG. 1B illustrates a skin-type determination process using the skin-type determining machine shown in FIG. 1A;

FIG. 2 illustrates a cosmetics dispensing system according to an embodiment of the present disclosure;

FIG. 3 is a schematic illustration of dispensing cylinder of the cosmetics a dispensing system shown in FIG. 2;

FIG. 4 illustrates a custom cosmetics system according to an embodiment of the present disclosure;

FIG. 5 illustrates a method of manufacturing a custom gel mask according to an embodiment of the present disclosure by using the cosmetics dispensing system shown in FIG. 2 and/or the custom cosmetics system shown in FIG. 4;

FIG. 6 illustrates a method of manufacturing a custom cosmetic product according to an embodiment of the present disclosure by using the cosmetics dispensing system shown in FIG. 2 and/or the custom cosmetics system shown in FIG. 4; and

FIG. 7 illustrates a method of manufacturing a custom cleansing tissue according to an embodiment of the present disclosure by using the cosmetics dispensing system shown in FIG. 2 and/or the custom cosmetics system shown in FIG. 4

### DETAILED DESCRIPTION

The present disclosure is directed toward various embodiments of a method of providing custom cosmetic products and a system providing the same. Aspects of embodiments of the present disclosure are directed to a method of providing custom cosmetic products (e.g., custom cosmetics) for a user (e.g., a customer) and to a system for producing the custom cosmetic products. Some embodiments of the method include producing a custom cosmetic product based on the user's particular skin characteristics and other embodiments of the method provide manual mixing of various ingredients to create a custom cosmetic product according to the user's desires.

Hereinafter, example embodiments of the present disclosure will be described, in more detail, with reference to the accompanying drawings. The present disclosure, however, may be embodied in various different forms and should not be construed as being limited to only the embodiments illustrated herein. Rather, these embodiments are provided as examples so that this disclosure will be thorough and complete and will fully convey the aspects and features of the present disclosure to those skilled in the art. Accordingly, processes, elements, and techniques that are not necessary to those having ordinary skill in the art for a complete understanding of the aspects and features of the present disclosure may not be described. Unless otherwise noted, like reference numerals denote like elements throughout the attached drawings and the written description, and thus, descriptions thereof may not be repeated.

It will be understood that, although the terms “first,” “second,” “third,” etc., may be used herein to describe various elements, components, and/or layers, these elements, components, and/or layers should not be limited by these terms. These terms are used to distinguish one element, component, or layer from another element, component, or layer. Thus, a first element, component, or layer described below could be termed a second element, component, or layer without departing from the scope of the present disclosure.

It will be understood that when an element or component is referred to as being “connected to” or “coupled to” another element or component, it may be directly connected or coupled to the other element or component or one or more intervening elements or components may also be present. When an element or component is referred to as being “directly connected to” or “directly coupled to” another element or component, there are no intervening element or component present. For example, when a first element is described as being “coupled” or “connected” to a second element, the first element may be directly coupled or connected to the second element or the first element may be indirectly coupled or connected to the second element via one or more intervening elements.

The terminology used herein is for the purpose of describing particular embodiments and is not intended to be limiting of the present disclosure. As used herein, the singular forms “a” and “an” are intended to include the plural forms as well, unless the context clearly indicates otherwise. It will be further understood that the terms “comprises,” “comprising,” “includes,” and “including,” when used in this specification, specify the presence of the stated features, integers, steps, operations, elements, and/or components but do not preclude the presence or addition of one or more other features, integers, steps, operations, elements, components, and/or groups thereof. That is, the processes, methods, and algorithms described herein are not limited to the operations indicated and may include additional operations or may omit some operations, and the order of the operations may vary according to some embodiments. As used herein, the term “and/or” includes any and all combinations of one or more of the associated listed items.

As used herein, the term “substantially,” “about,” and similar terms are used as terms of approximation and not as terms of degree, and are intended to account for the inherent variations in measured or calculated values that would be recognized by those of ordinary skill in the art. Further, the use of “may” when describing embodiments of the present disclosure refers to “one or more embodiments of the present disclosure.” As used herein, the terms “use,” “using,” and “used” may be considered synonymous with the terms “utilize,” “utilizing,” and “utilized,” respectively. Also, the term “example” is intended to refer to an example or illustration.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

A processor, memory, and/or any other relevant devices or components according to embodiments of the present disclosure described herein may be implemented utilizing any suitable hardware (e.g., an application-specific integrated circuit), firmware, software, and/or a suitable combination of software, firmware, and hardware. For example, the various components of the processor and/or the memory may be formed on (or realized in) one integrated circuit (IC) chip or on separate IC chips. Further, the various components of the processor and/or the memory may be implemented on a flexible printed circuit film, a tape carrier package (TCP), a printed circuit board (PCB), or formed on the same substrate as the processor and/or the memory. Further, the described actions may be processes or threads, running on one or more processors (e.g., one or more CPUs, GPUs, FPGAs, etc.), in one or more computing devices, executing computer program instructions and interacting with other system components to perform the various functionalities described herein. The computer program instructions may be stored in the memory, which may be implemented in a computing device using a standard memory device, such as, for example, a random access memory (RAM). The computer program instructions may also be stored in other non-transitory computer readable media such as, for example, a CD-ROM, flash drive, HDD, SSD, or the like. Also, a person of skill in the art should recognize that the functionality of various computing devices may be combined or integrated into a single computing device or the functionality of a particular computing device may be distributed across one or more other computing devices without departing from the scope of the exemplary embodiments of the present disclosure.

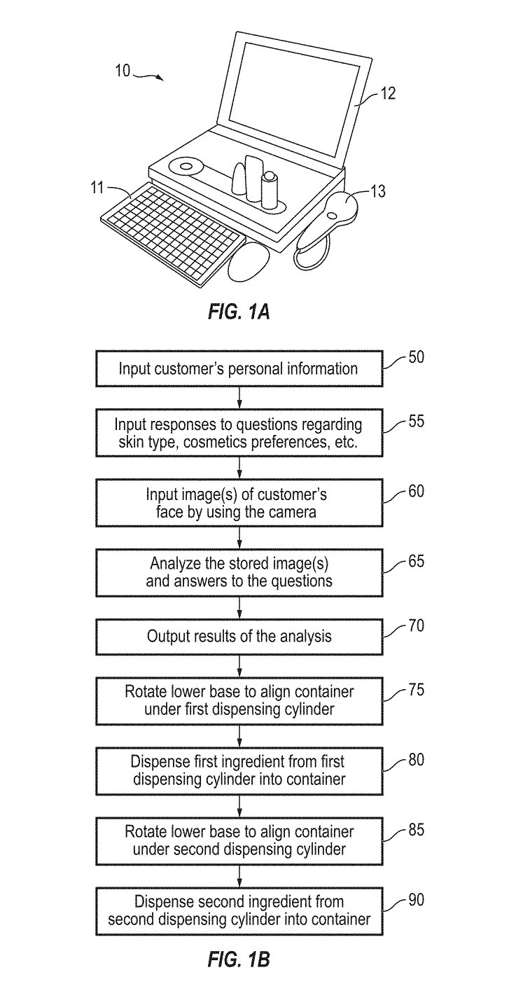

Referring to FIGS. 1A and 1B, when a user (e.g., a customer) visits a store to purchase custom cosmetics products, such as custom makeup, foundation, creams, ointments, gel masks, cleansing tissues, etc., a first step in providing the desired custom cosmetic products may be to determine the user's skin type. A machine (e.g., a skin-type determining machine or a general purpose computer configured to determine a user's skin type) 10 may be employed to determine the user's skin type and other characteristics, a trained employee may determine the user's skin type and other characteristics, or the trained employee may combine aspects of both the skin-type determining machine 10 and his or her own skills to determine the user's skin type and other characteristics.

The skin-type determining machine 10, according to an embodiment, may include a processor, memory connected to the processor, one or more input devices 11, such as a keyboard, mouse, etc., a display device 12, such as a monitor, and a camera 13. The skin-type determining machine 10 may be connected to a printer to output the results of the skin-type analysis, discussed further below, and/or may be connected to a cosmetics dispensing system 100, also discussed further below.

FIG. 1B illustrates a skin-type determination process using the skin-type determining machine 10. The user may input their (or the employee may input the user's) personal information (50) and may answer questions related to his or her skin type, cosmetics preferences, etc. (55) by using the input device 11 of the skin-type determining machine 10. The display device 12 of the skin-type determining machine 10 may display the questions and other prompts to direct the user or employee through the skin-type determining process.

The camera 13 of the skin-type determining machine may assist in determining the user's skin type. For example, the camera 13 may, in conjunction with the processor and the memory and with the answers to the questions described above, determine the user's skin type. For example, the user (or employee) may use the camera 13 to input an image or images of the user's face (60), may store the picture in the memory, and the processor may analyze the stored picture to determine T-zone (e.g., forehead, nose, and chin areas) and U-zone (e.g., cheek and chin areas) fat content, T-zone and U-zone grease content, T-zone and U-zone moisture content, dead skin content, etc. and may analyze the stored picture to determine skin pore size, amount, etc., wrinkle measurements, etc. (65).

The skin-type determining machine 10 may then store the results of the skin-type determination process in the memory and/or may print the result (70). The skin-type determining machine 10 may be connected to the cosmetics dispensing system 100, further described below. For example, the skin-type determining machine 10 may determine ingredients and amounts thereof to be mixed together by the cosmetics dispensing system 100 based on the results of the skin-type determination process, the cosmetics dispensing system 100 may determine the ingredients and amounts thereof to be mixed together by the cosmetics dispensing system based on the results of the skin-type determination process, or the user may use the results of the skin-type determination process to select the ingredients and amounts thereof to be mixed together by the cosmetics dispensing system 100. However, the present disclosure is not limited thereto, and the user may use any other suitable methods, tests, test results, and/or any other factors, such as the user's own random decision, to manually or semi-automatically select the ingredients and/or the amounts to be mixed. That is, the user may omit the skin-type determining process before using the cosmetics dispensing system 100 described below.

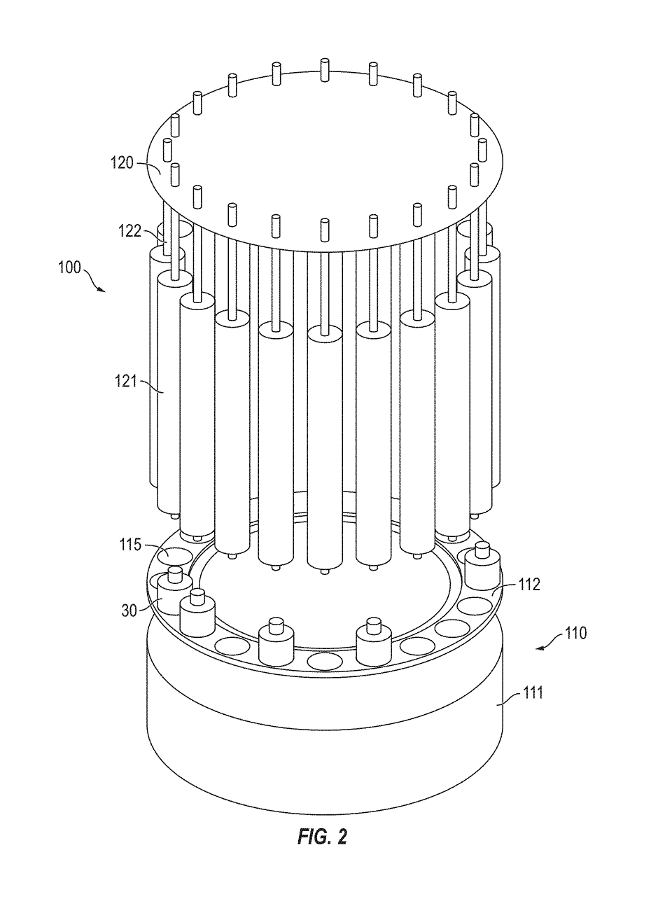

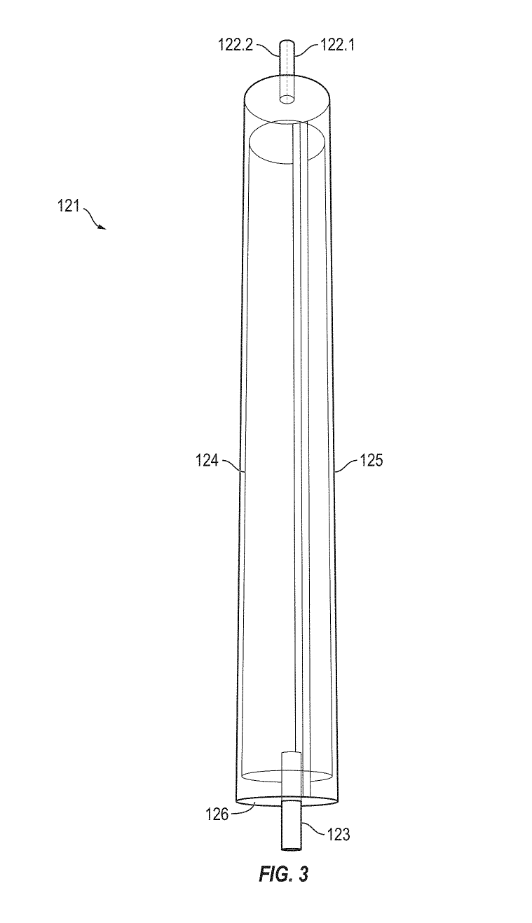

FIG. 2 shows an embodiment of the cosmetics dispensing system 100, and FIG. 3 is a schematic illustration of a dispensing cylinder 121 of the cosmetics dispensing system 100 shown in FIG. 2.

Referring to FIG. 2, the cosmetics dispensing system 100 may include a lower base 110 arranged under an upper base 120. The lower and upper bases 110 and 120 may be aligned with each other, as will be further described below.

The lower base 110 of the cosmetics dispensing system 100 may include a fixed lower base 111 and a rotatable lower base 112 rotatably coupled to the fixed lower base 111. The fixed lower base 111 may include a motor (e.g., a servo motor, a stepper motor, etc.) configured to rotate the rotatable lower base 112. Both the fixed and rotatable lower bases 111 and 112 may have a circular shape. The fixed lower base 111 may be fixed to a floor.

The rotatable lower base 112 may have a plurality of seats 115 arranged therein. In some embodiments, the rotatable lower base 112 may have approximately thirty seats 115, and a corresponding number of dispensing cylinders 121 (e.g., thirty dispensing cylinders 121) may be present. However, the present disclosure is not limited thereto, and in some embodiments, the rotatable lower base 112 may have approximately fifteen seats 115, and a corresponding number of dispensing cylinders 121 (e.g., fifteen dispensing cylinders 121) may be present. The seats 115 may be depressed portions of the rotatable lower base 112 or may be openings that extend through the rotatable lower base 112. The seats 115 are sized and configured to receive containers 30 (e.g., cosmetics containers, beakers, mask frames, tissue containers, etc.).

In other embodiments, instead of the seats 115, a plurality of hooks may be arranged along the rotatable lower base 112. The hooks may allow for greater flexibility as to the types, shapes, sizes, etc. of containers 30 that can be received on the rotatable lower base 112.

In some embodiments, the fixed lower base 111 and/or the rotatable lower base 112 may be cooled by, for example, recirculating a cooling gas inside the fixed lower base 111 and/or around the rotatable lower base 112. By cooling the fixed lower base 111 and/or the rotatable lower base 112, the containers 30 thereon may be kept at a relatively cool temperature throughout the filling process.

The containers 30 may be placed into the seats 115 (or onto the hooks) by the user, the employee, a robot, or any other suitable machine or device, and the containers 30 may then be filled with ingredients determined by, for example, the skin-type determination process described above with reference to FIGS. 1A and 1B. Once filled, the user, employee, robot, or other suitable machine or device may remove the filled containers 30 from the rotatable lower base 112. The filled container 30 may be a completed custom cosmetic product or may be used in later steps to form a custom cosmetic product, such as a gel mask.

The upper base 120 may be fixed to a ceiling, and a plurality of dispensing cylinders 121 (further described below with reference to FIG. 3) may be mounted the upper base 120, for example, such that they hang from the upper base 120. The upper base 120 may be fixed or may be rotatable. For example, in some embodiments, the upper base 120 may be fixed and the lower base 110 may include the rotatable lower base 112, and in other embodiments, the upper base 120 may be rotatable and the lower base 112 may be fixed along with the fixed lower base 111. In other embodiments, both the upper and lower bases 120 and 110 may be rotatable or moveable.

In some embodiments, the upper base 120 may be fixed to the lower base 110 by, for example, a column or support extending from a central area of the lower base 110 to the upper base 120. In such an embodiment, the lower base 110 and the upper base 120 may be a single unit, thereby reducing alignment issues between the lower and upper bases 110 and 120 and allowing for easier movement and/or installation of the cosmetics dispensing system 100.

The dispensing cylinders 121 may be configured to house the ingredients described above. The ingredients may include natural fruit extract, natural vegetable extract, various makeup preparations, fillers, oil, cream, etc. The natural fruit extract and natural vegetable extract may be created as-needed by pressing, grinding, etc. fruits and vegetables on-site that are then filled into the dispensing cylinders 121.

Referring to FIG. 3, the dispensing cylinders 121 may have a double-wall structure (or a double-cylinder structure) in which the ingredient is housed in an inner cylinder 124 while a cooling gas, such as chilled air, nitrogen, etc., is circulated between the inner cylinder and an outer cylinder wall 125 to maintain the ingredient at a relatively low temperature (e.g., at a fixed low temperature). The inner cylinder 124 may be a plastic bag or the like, which may be disposable. The inner cylinder 124 may be purchased filled with an ingredient or may be filled on-site, as described above and as further described below. However, in other embodiments, the inner cylinder 124 may be a rigid, reusable plastic cylinder, a glass cylinder, or any other suitable material.

A pipe or tube 122 may extend from each of the dispensing cylinders 121 through the upper base 120. The pipe or tube 122 may allow for the circulation (e.g., the inlet and outlet) of the cooling gas into the dispensing cylinders 121 (e.g., into a space between the outer cylinder wall 125 and the inner cylinder 124). For example, the pipe or tube 122 may be segregated internally to have an inlet side 122.1 and an outlet side 122.2. The inlet side 122.1 of the pipe or tube 122 may be connected to (or in fluid communication with) a refrigeration unit to provide the cooling gas to the dispensing cylinder 121. The refrigeration unit may be included above the upper base 120 (e.g., in a ceiling above the upper base 120) or may be included in the lower base 110, for example, in the fixed lower base 111. When the refrigeration unit is in the fixed lower base 111 and when the lower and upper bases 110 and 120 are fixed to each other, a pipe or hose may extend from the central area of the lower base 110 to the upper base 120 through the column or support to provide the cooling gas to the dispensing cylinders 121.

The dispensing cylinders 121 may include a nozzle 123 at a bottom thereof that extends from the inner cylinder 124 to outside of the outer cylinder wall 125. The nozzle 123 allows for the dispensing of the ingredient housed in the inner cylinder 124. The nozzle 123 may include a valve (e.g., an electronically-controlled valve) to control the flow of the ingredient to or from the inner cylinder 124.

The ingredient housed in the inner cylinder 124 may be dispensed by, for example, increasing air pressure between the outer cylinder wall 125 and the inner cylinder 124. In some embodiments, the air pressure may be increased by selectively closing the outlet side 122.2 of the pipe or tube 122. However, the present disclosure is not limited thereto, and in other embodiments, the ingredient housed in the inner cylinder 124 may be dispensed by being pushed out of the inner cylinder 124 by, for example, a pneumatic or hydraulic cylinder or an air-filled bladder may be included on the outer cylinder wall 125 to squeeze the inner cylinder 124. In some embodiments, the valve in the nozzle 123 may be selectively opened and closed to control the flow of the ingredient from the inner cylinder 124.

The dispensing cylinder 121 may also include a door 126 at the bottom thereof. The door 126 may be at the bottom of the outer cylinder wall 125 (e.g., may form the bottom of the dispending cylinder 121) and may be hingedly connected to the side walls of the outer cylinder wall 125. By opening the door 126 of the dispensing cylinder 121, the inner cylinder 124 may be removed from inside the outer cylinder wall 125, refilled with the ingredient or with another ingredient, cleaned, etc., and then replaced into the outer cylinder wall 125.

In other embodiments, the pipe or tube 122 (e.g., the inlet side 122.1 of the pipe or tube 122) may allow for the inner cylinder 124 of the dispensing cylinder 121 to be filled with the ingredients, or another pipe or tube may be provided that extends into the inner cylinder 124 to allow the inner cylinder 124 to be filled with the ingredients.

The user may use the skin-type determining machine 10, the cosmetics dispensing system 100, a custom cosmetics system 200, further described below, and other suitable devices and systems as part of a self-service plan to manufacture single or small-batch custom cosmetic products based on the user's individual skin type, condition, and other factors.

Referring to FIG. 1B, after having used the skin-type determining machine 10, the user, employee, robot, or other suitable machine or device may place a container 30 into one of the seats 115 of the rotatable lower base 112. The container 30 may have a barcode label or the like placed thereon to track the container 30. When the skin-type determining machine 10 and the cosmetics dispensing system 100 are not connected to each other, the skin-type determining machine 10 may print the barcode label, and the cosmetics dispensing system 100 may read the barcode label to determine which ingredients in what amounts should be mixed in the container 30. However, in other embodiments, the cosmetics dispensing system 100 may receive information from the skin-type determining machine 10 (e.g., may receive information through a wired connection or over a wireless network, etc.) including the ingredients and amount thereof to be mixed in the container 30 to create the custom cosmetic product based on the user's results, or the cosmetic dispensing system 100 may receive information from the skin-type determining machine 10 including the user's skin-type and other information, as described above, to determine which ingredients and amounts thereof to be mixed in the container 30. However, in some embodiments, selection of the ingredients may be left to the discretion of the user based on his or desires or any other factor (e.g., scent or aesthetically pleasing color of the ingredients) that is important to the user.

Next, the rotatable lower base 112 rotates such that the container 30 is arranged under a first dispensing cylinder 121 that houses a first ingredient (75). Then, the first ingredient is dispensed from the first dispensing cylinder 121 into the container 30. The first ingredient (e.g., a determined amount of the first ingredient) may be dispensed from the dispensing cylinder 121 by opening a valve in the dispensing cylinder 121 (e.g., a valve in the inner cylinder 124), and the dispensing cylinder 121 may, for example, rely on gravity to dispense the first ingredient or compressed air may be introduced into the inner cylinder 124 to dispense the first ingredient (80). However, the dispensing cylinders 121 are not limited thereto.

After the first ingredient is deposited into the container 30, the rotatable lower base 112 rotates such that the container 30 is arranged under a second dispensing cylinder 121 that houses a second ingredient (85). The second dispensing cylinder 121 then dispenses the second ingredient (e.g., a determined amount of the second ingredient) into the container 30 (90).

The above described process of rotating the rotatable lower base 112 to arrange the container 30 under different ones of the dispensing cylinders 121 and dispensing ingredients from the dispensing cylinders 121 into the container 30 may be repeated until all of the determined ingredients have been dispensed into the container 30 to provide the custom cosmetic product according to the skin-type determination and/or the user's desires.

In addition, an additional mixing step may be provided after the final ingredient is dispensed into the container 30. The mixing step may be provided by, for example, rapidly spinning the rotatable lower base 112, such as a centrifuge, the user, employee, robot, or other suitable machine or device may remove the container 30 from the rotatable lower base 112 and place the container 30 into a separate mixing machine, or the user, employee, robot, or other suitable machine or device may mix (e.g., may manually mix) the ingredients by shaking the container 30.

Further, to concurrently provide custom cosmetic products for a plurality of customers or to concurrently provide a plurality of custom cosmetic products to a single user, a plurality of the containers 30 may be placed on the rotatable lower base 112 and then rotated as described above. However, in such an embodiment, some of the containers 30 may be, at certain steps, arranged under dispensing cylinders 121 that house ingredients not intended for that container 30. In this instance, the dispensing cylinder 121 would not dispense its ingredients into the container 30, and the container 30 and the corresponding dispensing cylinder 121 would wait (e.g., would remain idle). Thus, a plurality of containers 30 could be filled concurrently (and/or simultaneously) even when some of the containers 30 do not receive ingredients from each of the dispensing cylinders 121.

Further, aspects of the above-described embodiments of the cosmetics dispensing system 100 may be applied to (e.g., employed in) a system for creating mixed beverages or the like. For example, rather than including the cosmetics liquid (e.g., the cosmetics serum or extract) in the dispensing cylinders 121, a beverage or mixer, such as natural fruit extract, natural vegetable extract, alcoholic beverage, water, sparkling water, natural or artificial sweetener, and/or coloring extract, may be stored in the dispensing cylinders 121. Further, a user, employee, robot, or other suitable machine or device may place an empty container, such as an empty drink container, on the rotating lower base 112 and a selected drink may be mixed similar to how the above-described embodiments mix cosmetics.

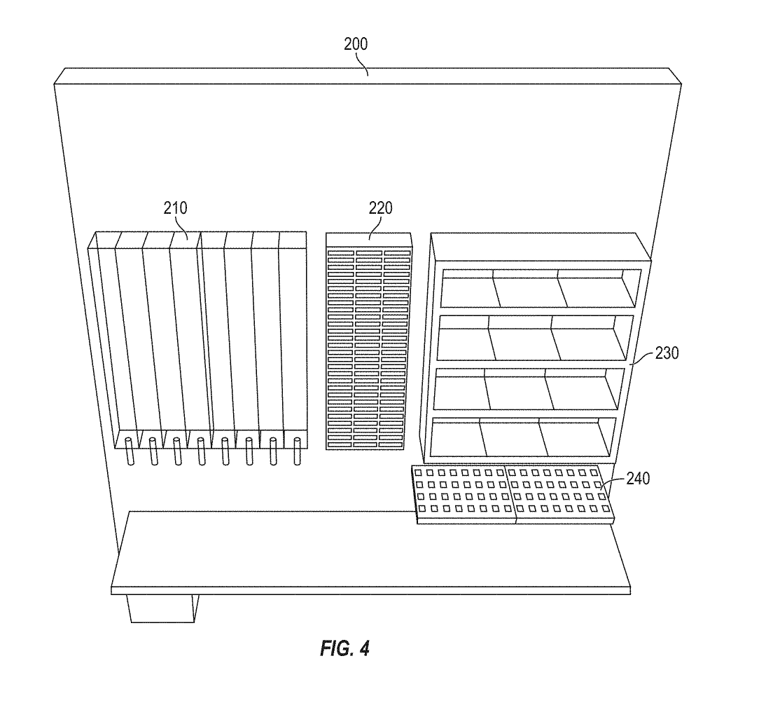

FIG. 4 shows various aspects of another embodiment of a system for manufacturing custom cosmetic products.

In FIG. 4, a custom cosmetics system 200 includes ingredient storage containers 210, a mask pack 220, a shelf 230, and a table 240. The ingredient storage containers 210, the mask pack 220, the shelf 230, and the table 240 may be mounted onto a wall (e.g., a common wall) such that gel mask trays (e.g., mask frames) and other cosmetics containers may be easily moved between the different components of the custom cosmetics system 200. In addition, the wall may be cooled (e.g., may be cooled from behind by cooling air or another cooling fluid) to maintain all components or stations of the custom cosmetics system 200 while remaining at a relatively cool temperature.

The ingredient storage containers 210 may store natural fruit extract, natural vegetable extract, etc., similar to or the same as the ingredients housed in the dispensing cylinders 121, as described above, and/or may store other ingredients, which may be used to produce the custom cosmetics described with respect to FIGS. 1B and 2 or to produce a custom gel face mask, as further described below, or other custom cosmetics. In some embodiments, the ingredient storage containers 210 may include a squeezing or compression device, such as a compression cylinder or the like, to squeeze fruits and/or vegetables to create the natural fruit and vegetable extract in the ingredient storage containers 210. In embodiments in which the ingredient storage containers 210 include the squeezing or compression device, the natural fruit or vegetable extract may be discharged from the ingredient storage containers 210, as further described below, and inputted into the dispensing cylinders 121 of the cosmetics dispensing system 100, shown in FIG. 2. The ingredient storage containers 210 may also include an ultraviolet and/or infrared light source to sterilize the ingredients therein. To reduce or prevent leakage of the ultraviolet and/or infrared light from the ingredient storage containers 210, the ingredient storage containers 210 may include (e.g., may be formed of) a protective plastic that reduces or prevents transmission of the ultraviolet and/or infrared light.

Generally, cosmetic products have a shelf-life between three and four years. However, the natural cosmetic ingredients described herein may have a shelf-life of about seven days as they do not include preservatives (or have little or less preservatives than conventional cosmetic products). To ensure that the natural cosmetic ingredients remain fresh throughout their shelf life, the wall onto which the ingredient storage containers 210 and the mask pack 220 are mounted is cooled, such that the ingredients therein (e.g., the natural cosmetics therein) may be cooled.

The mask pack 220 may include a number of openings (e.g., slots) to accommodate the gel mask trays and/or other containers, to be further described below. The mask pack 220 may be cooled by being attached to the wall. In some embodiments, the mask pack 220 may include an ultraviolet and/or infrared light source (e.g., a low-temperature ultraviolet light and/or a high-infrared light source). In some embodiments, a common ultraviolet and/or infrared light source may be provided to illuminate the slots of the mask pack 220, and in other embodiments, separate ultraviolet and/or infrared light sources may be provided in each of the slots to separately illuminate each of the slots of the mask pack 220.

The shelf 230 may have a plurality of levels and may accommodate the gel mask trays after a gel mask is removed therefrom, to be further described below, and/or other cosmetics containers, such as beakers, cleansing tissue cases (with or without tissues therein), dry cleaning cloths, etc. In addition, the shelf 230 may include an ultraviolet and/or infrared light source to disinfect the gel mask trays and other cosmetics containers after being used and before being used again. The ultraviolet and/or infrared light source may be continuously operated (e.g., continuously operated during working hours) to sterilize the gel mask trays and other cosmetics containers between uses.

To protect a user and/or employees, a protective door may be included on one or both of the mask pack 220 and the shelf 230. The protective door may ensure proper cooling of the gel mask trays inserted into the slots of the mask pack 220 and may prevent or reduce an amount of ultraviolet and/or infrared light that escapes the shelf 230. An individual door may be provided for each of the slots of the mask pack 220 or a single door may be provided to cover all of the slots. Similarly for the shelf 230, a single door may be provided to cover the entire shelf 230 or separate doors may be provided for each level of the shelf 230. However, the present disclosure is not limited thereto, and in some embodiments, the door(s) may be omitted.

The table 240 may be an area on which the gel mask trays and/or other containers may be placed at various times during the process of manufacturing custom cosmetics, to be further described below. In addition, collagen tablets, to be further described below, may be arranged on the table 240.

Further, a sealing machine may be included to seal (e.g., vacuum seal, plastic wrap, etc.) the completed custom cosmetic products.

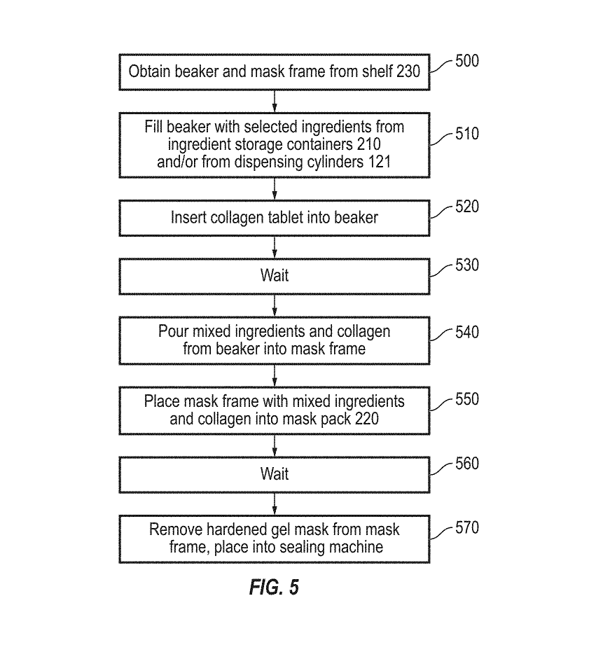

Referring to FIG. 5, a method of manufacturing a custom gel mask using the cosmetics dispensing system 100 shown in FIG. 2 and/or the custom cosmetics system 200 shown in FIG. 4 is illustrated.

First, a user, employee, robot, or other suitable machine or device selects a beaker and a mask frame (e.g., a gel mask tray) from a stock (e.g., a clean stock) or from the shelf 230 (500). The mask frame may have been sanitized (or sterilized) by the ultraviolet and/or infrared light source(s) in the shelf 230.

In one embodiment, the user, employee, robot, or other suitable machine or device fills the beaker with selected ingredients from the ingredient storage containers 210 (510). For example, each of the ingredient storage containers 210 may have a valve at a bottom thereof that can be manually operated to discharge the ingredient stored therein.

In another embodiment, the user, employee, robot, or other suitable machine or device places the beaker onto the rotatable lower base 112 of the cosmetics dispensing system 100, and then, the cosmetic dispensing system 100 operates as described above to fill the beaker with certain ingredients. The user or employee may select certain ingredients to be deposited into the gel mask tray based on the user's desires, needs, etc.

Then, the user, employee, robot, or other suitable machine or device inserts a collagen tablet, such as one of the collagen tablets arranged on the table 240, into the beaker with the ingredients (520). The collagen tablet acts as a hardening agent to harden the ingredients into a gel state. The beaker with the ingredients and the collagen may be left for approximately one minute to begin hardening (530).

Then, the user, employee, robot, or other suitable machine or device pours the mixed ingredients and collagen from the beaker into the mask frame (540).

The user, employee, robot, or other suitable machine or device then places the mask frame with the mixed ingredients and collagen therein into one of the slots of the mask pack 220 to be cured (550). The curing may occur due to the mask pack 220 being cooled, as described above, or the ultraviolet and/or infrared light sources may be provided in the mask pack 220 to assist with the curing. In some embodiments, the ultraviolet and/or infrared light source may be automatically activated (e.g., automatically activated after a time delay) after determining the mask frame has been placed in the mask pack 220.

After an amount of time (560), the ingredients in the mask frame are hardened to form the custom gel mask. Then, the user, employee, robot, or other suitable machine or device may remove the hardened gel mask from the mask frame and may place it into packaging (570). Then, the packaged hardened gel mask may be placed into the sealing machine to be sealed for transport by the user (e.g., the customer).

The used mask frame and the beaker may then be placed onto the shelf 230 to be sterilized for another use by the ultraviolet and/or infrared light source. Once sterilized, the mask frame and the beaker may be returned to stock or may be picked up by another user or employee or by the robot or other suitable machine or device from the shelf 230 to be used again to manufacture another custom gel mask.

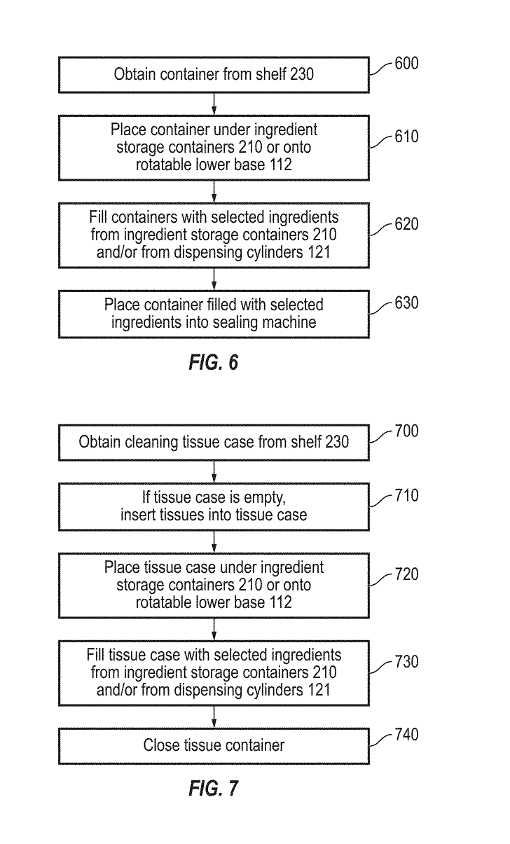

Referring to FIG. 6, a method of manufacturing a custom cosmetic product using the cosmetics dispensing system 100 shown in FIG. 2 and/or the custom cosmetics system 200 shown in FIG. 4 is illustrated.

First, a user, employee, robot, or other suitable machine or device obtains a container from a stock or from the shelf 230 (600).

Then, the user, employee, robot, or other suitable machine or device places the container under the ingredient storage containers 210 (610) and fills the container with the selected ingredients (620). In other embodiments, the user, employee, robot, or other suitable machine or device places the container on the rotatable lower base 112 of the cosmetics dispensing system 100 (610), and then, the container is automatically filled with selected ingredients from the dispensing cylinders 121 (620). However, the present disclosure is not limited to these embodiments, and in other embodiments, the container may be filled both by the ingredient storage containers 210 and by the dispensing cylinders 121.

Once the container is filled with the selected ingredients, it is then placed into the sealing machine (630) to be sealed for transport by the user (e.g., the customer).

Referring to FIG. 7, a method of manufacturing a custom cleansing tissue using the cosmetics dispensing system 100 shown in FIG. 2 and/or the custom cosmetics system 200 shown in FIG. 4 is illustrated.

First, a user, employee, robot, or other suitable machine or device obtains a cleansing tissue case from a stock or from the shelf 230 (700). The cleansing tissue case may be prefilled with cleansing tissues or may be empty. When the cleansing tissue case is empty, a user, employee, robot, or other suitable machine or device may place cleansing tissues into the cleansing tissue case (710). In other embodiments, the cleansing tissues may be placed into the cleansing tissue case after the ingredients are deposited into the case, to be described below.

Then, the user, employee, robot, or other suitable machine or device places the tissue case under the ingredient storage containers 210 (720) and fills the tissue case with the selected ingredients (730). In other embodiments, the user, employee, robot, or other suitable machine or device places the tissue case on the rotatable lower base 112 of the cosmetics dispensing system 100 (720), and then, the tissue case is automatically filled with selected ingredients from the dispensing cylinders 121 (730). However, the present disclosure is not limited to these embodiments, and in other embodiments, the tissue case may be filled both by the ingredient storage containers 210 and by the dispensing cylinders 121.

Once the tissue case is filled with the selected ingredients, it is then closed to be transported by the user (e.g., the customer). However, if the tissues are not in the tissue case after the ingredients are deposited into the case, the user, employee, robot, or other suitable machine or device places tissues into the tissue case before the tissue case is closed.

Although the present disclosure has been described with reference to the example embodiments, those skilled in the art will recognize that various changes and modifications to the described embodiments may be made, all without departing from the spirit and scope of the present disclosure. Furthermore, those skilled in the various arts will recognize that the present disclosure described herein will suggest solutions to other tasks and adaptations for other applications. It is the applicant's intention to cover, by the claims herein, all such uses of the present disclosure, and those changes and modifications which could be made to the example embodiments of the present disclosure herein chosen for the purpose of disclosure, all without departing from the spirit and scope of the present disclosure. Thus, the example embodiments of the present disclosure should be considered in all respects as illustrative and not restrictive, with the spirit and scope of the present disclosure being indicated by the appended claims and their equivalents.

What is claimed is:

1. A system for providing custom cosmetic products, the system comprising:
a lower base configured to receive a plurality of containers;
an upper base; and
a plurality of dispensing cylinders coupled to the upper base, the dispensing cylinders being configured to selectively deposit cosmetic ingredients into the containers.

2. The system of claim 1, wherein the lower base comprises:
a fixed lower base; and
a rotatable lower base rotatably coupled to the fixed lower base, the rotatable lower base being configured to receive the containers.

3. The system of claim 2, wherein the containers received by the rotatable lower base are aligned with the dispensing cylinders.

4. The system of claim 2, wherein the rotatable lower base is configured to rotate to align the containers with different ones of the dispensing cylinders.

5. The system of claim 2, wherein each of the dispensing cylinders comprises an inner cylinder and an outer wall spaced apart from the inner cylinder.

6. The system of claim 5, wherein the inner cylinder is configured to receive the cosmetic ingredient.

7. The system of claim 6, further comprising a refrigeration unit in the lower base, the refrigeration unit being connected to the dispensing cylinders and being configured to provide a cooling gas to a space between the inner cylinder and the outer wall of the dispensing cylinders.

8. The system of claim 1, wherein the upper base is configured to rotate relative to the lower base.

9. The system of claim 8, wherein the upper base and the lower base are coupled to each other by a support extending from the lower base to the upper base.

10. A method of producing a custom cosmetic product by using a cosmetics dispensing system, the method comprising:
receiving a skin type analysis result;
rotating a lower base of the cosmetics dispensing system such that a container accommodated on the lower base is aligned under a first one of a plurality of dispensing cylinders; and
dispensing a first ingredient from the first one of the dispensing cylinders into the container.

11. The method of claim 10, further comprising:
rotating the lower base such that the container is aligned under a second one of the dispensing cylinders; and
dispensing a second ingredient from the second one of the dispensing cylinders into the container.

12. The method of claim 11, further comprising providing a cooling gas from a refrigeration unit in the lower base to the dispensing cylinders.

13. The method of claim 12, wherein the cooling gas is provided to the dispensing cylinders via inlet openings in the dispensing cylinders, and
wherein the dispensing of the first ingredient comprises closing an outlet valve in the first one of the dispensing cylinders to increase pressure in the first one of the dispensing cylinders.

14. The method of claim 11, wherein the dispensing of the first ingredient comprises opening a valve at a bottom of the first one of the dispensing cylinders.

15. The method of claim 14, wherein the dispensing of the first ingredient further comprises increasing pressure in the first one of the dispensing cylinders by using a piston.

16. The method of claim 11, further comprising centrifuging the container by spinning the lower base after the dispensing of the second ingredient.

17. A method of producing a custom cosmetic product by using a cosmetics dispensing system, the method comprising:
receiving a skin type analysis result;
rotating an upper base of the cosmetics dispensing system such that a first one of a plurality of dispensing cylinders is aligned over a container accommodated on a lower base of the cosmetics dispensing system; and
dispensing a first ingredient from the first one of the dispensing cylinders into the container.

18. The method of claim 17, further comprising:
rotating the upper base such that a second one of the dispensing cylinders is aligned over the container; and
dispensing a second ingredient from the second one of the dispensing cylinders into the container.

19. The method of claim 18, further comprising mixing the first and second ingredients in the container.

20. The method of claim 18, further comprising providing a cooling gas from a refrigeration unit in the lower base to the dispensing cylinders.
